(19) United States
(12) Patent Application Publication
(10) Pub. No.: US 2016/0339281 A1
(43) Pub. Date: Nov. 24, 2016

(54) INTUMESCENT FIRE PROTECTION INSERT AND ASSEMBLY WITH INTUMESCENT FIRE PROTECTION INSERT

(71) Applicant: HILTI AKTIENGESELLSCHAFT, Schaan (LI)

(72) Inventor: Herbert Muenzenberger, Wiesbaden (DE)

(73) Assignee: Hilti Aktiengesellschaft, Schann (LI)

(21) Appl. No.: 14/902,140

(22) PCT Filed: Jul. 3, 2014
(86) PCT No.: PCT/EP2014/064151

§ 371 Date: Dec. 30, 2015

(30) Foreign Application Priority Data
Jul. 3, 2013 (EP) 13174854.3

(51) Int. Cl. A62C 3/16; H02G 3/08; A62C 2/06

(52) U.S. Cl. CPC A62C 3/16; A62C 2/065; H02G 3/088

(57) ABSTRACT

An intumescent fire protection insert for form-fitting insertion in an electrical junction box with a bottom and a peripheral wall which joins the bottom, is disclosed. The fire protection insert includes a planar base body, where the planar base body has a shape of the bottom of the electrical junction box, and a side element, where the side element is pivotably mounted on an edge of the planar base body and where the side element has a shape of a section of the peripheral wall of the electrical junction box.

This application claims the priority of International Application No. PCT/EP2014/064151, filed Jul. 3, 2014, and European Patent Document No. 13174854.3, filed Jul. 3, 2013, the disclosures of which are expressly incorporated by reference herein.

### BACKGROUND AND SUMMARY OF THE INVENTION

The invention relates to an intumescent fire protection insert for electrical junction boxes in walls or ceilings.

For fire protection reasons and also to prevent the penetration of noise or drafts, it is desired to seal off electrical junction boxes in walls or ceilings. Seals known to date can fulfill only one or two of these requirements. Seals against drafts do offer a certain noise protection, but only a slight amount of protection against fire due to the material. In contrast, fire protection elements can be integrated in electrical junction boxes only with great difficulty since the connections to cable ducts, which are installed in the walls, must be sealed off, too. In addition, the installation space within such electrical junction boxes is limited. Furthermore, there is a need to improve fire protection and comfort in existing buildings by equipping electrical junction boxes already in place with fire, noise, and draft protection at a later time.

Therefore, the object of the invention is to provide an intumescent fire protection insert that allows a sealing of electrical junction boxes against noise and drafts both in the event of fire and in normal use, and that can be retrofitted in walls and ceilings for existing electrical junction boxes.

To achieve the object, an intumescent fire protection insert is provided for the form-fitting insertion in an electrical junction box in walls or ceilings, which has a bottom and a peripheral wall joining the bottom, with a planar base body that has the shape of the electrical junction box bottom, as well as at least one side element that is pivotably seated on one edge of the base body and has the shape of a section of the peripheral wall. The invention is based on the idea of providing an insert for electrical junction boxes that meets all requirements for fire protection as well as noise and draft protection. This insert is inserted in the electrical junction box, which is already mounted on the wall or ceiling, for example cast into these. The electrical installations are then mounted in the electrical junction box. Cables, which are to be connected to the electrical installations, can already be laid prior to inserting this fire protection insert so that their laying is not complicated by the fire protection insert.

The fire protection insert happens to be designed in a pre-installed state in such a manner that enables simple transport and space-saving storage. The fire protection insert has a base body that, in an installed state, lies flat on the bottom of the electrical junction box and covers it entirely, at least however in the region of openings for cables or lines. Likewise, the side element, which is pivotably seated on the base body, partially covers the peripheral wall, at least however in the region of openings. For lines, recesses may be provided in the base body or in the side element, whereby these are adapted in such a manner that, in the peripheral direction, the fire protection insert lies entirely against the line or cable so that the openings are sealed against noise and drafts, whereby good protection against the penetration of noise or draft is established. In the event of fire, the material of the fire protection insert foams as the temperature increases and thereby also seals the electrical junction box or the openings and apertures for cables or lines of the electrical junction box.

Since the fire protection insert is inserted in the electrical junction box, one can also retrofit existing electrical junction boxes. In addition, no special precautionary measures are required on the electrical junction boxes themselves to install the fire protection insert so that already installed electrical junction boxes can continue to be used. In particular, one can also adapt the fire protection insert to the shape of the electrical junction box.

Then at least one side element is preferably connected in a one-piece manner to the base body so that no gap can form between the base body and the side element. In addition, shipping and installation are made easier since the side element cannot get lost.

The side element can be pivotably seated on the base body in various ways. If these are connected to each other in a one-piece manner, between the base body and the side element for example, there is provided at least one folding edge about which the side element can be pivoted. In particular, this folding edge can be formed by a groove.

On the edges of the base body and/or on the edges of the at least one side element, a bead or a thickening may also be provided. When inserting the electrical installation, this bead or thickening is also pressed in such that an improved seal against noise or drafts can be achieved.

During the installation process, one can arrange recesses, through which cables or lines can be run, on the base body or side part. However, it is also conceivable that on the base body and/or on the at least one side element, at least one aperture is provided for a cable or a line. To ensure that this aperture does not form a penetration opening for noise or drafts when not in use, this aperture is preferably formed by a breakaway section that is first opened when installing the fire protection insert or a cable. This breakaway section can preferably be opened without a tool or by simple means so that one can easily lay cables. If the fire protection insert is used for standardized electrical junction boxes, a plurality of such apertures can be provided with a breakaway section at the frequently used positions for a cable aperture.

Depending on the shape of the electrical junction box, a plurality of side elements may be provided, which are distributed particularly on the edge of the base body and together have the shape of the peripheral wall. By means of such a fire protection insert, the electrical junction box can be completely lined on the inside, whereby particularly good fire protection as well as a very good seal against noise and drafts can be achieved. However, it is also possible to provide a plurality of side elements that cover the peripheral wall only in the region of openings or apertures for cables or lines.

To further fix the fire protection insert, two or more side elements, preferably two opposing side walls, can be equipped in such a manner that in an installed state, i.e., in an implemented state, they project beyond the side walls of the electrical junction box. The part, projecting beyond the electrical junction box, of the side element of the fire protection insert is then bent and fixed along with the electrical installation to the structural element by fastening means, such as screws. In the event of a fire, when the electrical junction box softens or begins to melt and no longer has any retention to the structural element such that it falls down, one can hereby prevent the fire protection insert from also being carried along. The latter would then become ineffective. By the additional fixing to the structural element, the fire protection insert remains in the structural element opening and can seal it in the case of fire. The part projecting beyond the side walls of the electrical junction box can be designed in a one-piece manner with the side element, or be connected as an additional element to the side element, which may be furnished with a folding edge for easier bending. The add-on element can then be pivoted about this folding edge.

The fire protection insert preferably comprises a foamable binding agent that contains an intumescent substance mixture. The binding agent thereby serves as a bond-forming carrier for the intumescent substance mixture. Preferably, the substance mixture is homogeneously distributed in the binding agent. The bond-forming carrier is preferably selected from the group consisting of polyurethanes, phenol resins, polystyrenes, polyolefins, such as polyethylene and/or polybutylene, melamine resins, melamine resin foams, synthetic or natural rubber, cellulose, elastomers and blends thereof, wherein polyurethane is preferred.

The intumescent substance mixture comprises the conventional fire protection additives known to a person skilled in the art, which in the event of fire, in other words when subjected to heat, foam and thereby form a flame propagation-preventing foam, such as an intumescent material based on an acid-forming substance, a carbon-supplying compound, and a gas-forming substance. Preferably, the intumescent material comprises: as acid-forming substances, a salt or an ester of an inorganic, non-volatile acid selected from sulfuric acid, phosphoric acid, and boric acid; as a carbon-supplying compound a polyhydroxy compound and/or a thermoplastic or thermosetting polymeric resin binding agent; and as a gas-forming substance, a chlorinated paraffin, melamine, a melamine compound particularly melamine cyanurate, melamine phosphate, melamine polyphosphate, tris(hydroxyethyl)-cyanurate, cyanamide, dicyanamide, dicyandiamide, biguanidine, and/or a guanidine salt, particularly guanidine phosphate or guanidine sulfate.

The bond-forming carrier can also contain as an ablative additive an inorganic compound, which has water, e.g., as crystal water, firmly embedded in it and does not dry out at temperatures up to 100° C., but does release it starting at 120° C. in the event of fire. Temperature-conducting parts can thereby be cooled. Preferred is an inorganic hydroxide or hydrate releasing water at the fire temperature or when exposed to flame, particularly aluminum hydroxide, aluminum oxide hydrates or partially hydrated aluminum hydroxides. However, one can consider other inorganic hydroxides or hydrates releasing water when exposed to flame, as they are described in EP 0 274 068 A2.

Such compounds that can be used as substance mixtures in the fire protection insert according to the invention are known to a person skilled in the art and are disclosed for example in the following publications, which are hereby explicitly referred to: DE 30 25 309 A1, DE 30 41 731 A1, DE 33 02 416 A1, DE 34 11 327 A1, EP 0 043 952 B1, EP 0 051 106 B1, EP 0 061 024 B1, EP 0 116 846 B1, EP 0 158 165 B1, EP 0 274 068 A2, EP 1 347 549 A1, EP 1 641 895 B1 and DE 196 53 503 A1.

The fire protection insert can be produced for example by mold foaming, such as reaction foaming (RIM) according to DE 3917518, e.g., with Fomox® fire protection foam or the barrier layer-forming construction material HILTI CP 65GN. Materials that can be used for purposes according to the invention are known from EP 0061024 A1, EP 0051106 A1, EP 0043952 A1, EP 0158165 A1, EP 0116846 A1 and US 3,396,129 A as well as EP 1347549 A1. The molded object preferably consists of an intumescence-capable polyurethane foam as it is known from EP 0061024 A1, DE 3025309 A1, DE 3041731 A1, DE 3302416 A and DE 3411 327 A1.

However, to improve the stability of the foamed fire protection insert, glass fibers may also be embedded in the fire protection insert, by means of which one can achieve a substantially higher stability of the foamed material. The fire protection insert can for example have a core made of glass fibers, particularly made of a glass fiber fabric. This also improves the stability in machining the fire protection insert so that simpler installation of the fire protection insert, particularly a simpler folding or pivoting of the side elements is possible.

To achieve the object, there is also provided an assembly with such a fire protection insert as well as with an electrical junction box. The electrical junction box has a base as well as a peripheral wall joining the base, wherein the base body of the fire protection element completely covers the bottom and the side elements completely cover the peripheral wall of the electrical junction box.

Additional advantages and features are found in the following description in conjunction with the attached drawings.

### BRIEF DESCRIPTION OF THE DRAWINGS

FIG. 1 depicts a fire protection insert according to the invention, and

FIG. 2 depicts an assembly according to the invention with an electrical junction box and the fire protection insert from FIG. 1.

### DETAILED DESCRIPTION OF THE DRAWINGS

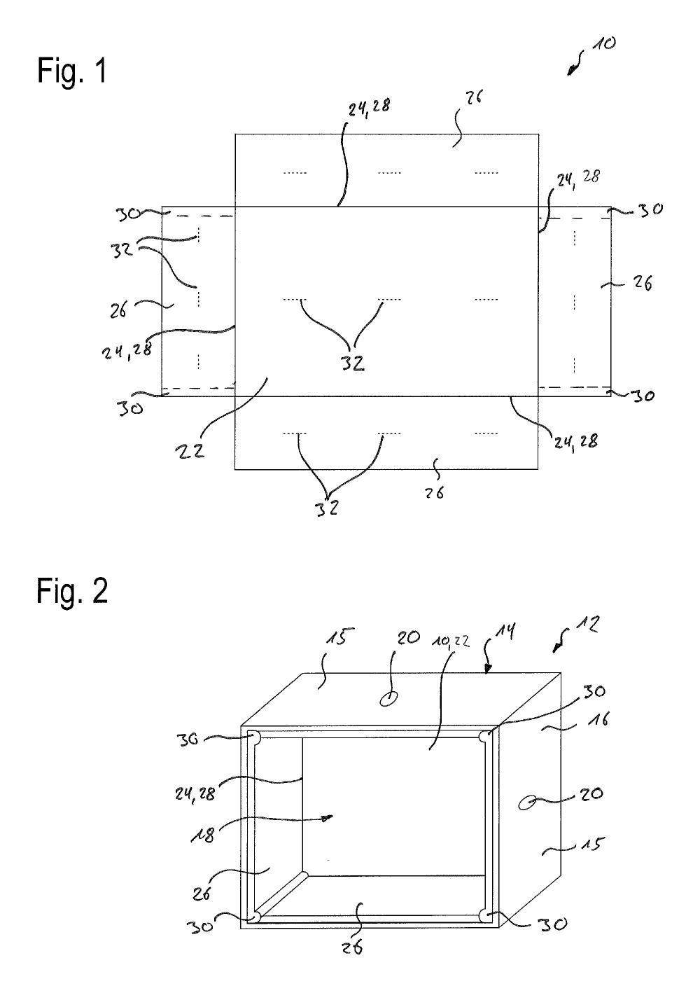

FIG. 1 depicts an intumescent fire protection insert 10 for inserting in an electrical junction box 12 depicted in FIG. 2. Such electrical junction boxes 12 are mounted in walls or ceilings to install electrical installations, for example light switches or electrical sockets. Electrical junction boxes 12 are either installed in recesses in the walls or cast into concrete walls for example when these are produced.

Electrical junction box 12 has a bottom 14 as well as a peripheral wall 16 consisting of a plurality of side walls 15, which define a receiving space 18 for an electric installation, for example an electrical socket or a light switch. There is a plurality of openings 20 provided on peripheral wall 16. On these openings 20, one can connect cable conduits to run lines into receiving space 18. Additional openings may be provided on bottom 14 of electrical junction box 12.

Depending on the size of openings 20 or the conduits connected to openings 20, noise or drafts may penetrate between adjoining rooms. For this reason, sealing openings 20 against noise and drafts is desired. In addition, in the event of fire, the penetration of fire or smoke through openings 20 and the lines or conduits into other rooms is to be prevented.

Intumescent fire protection insert 10, depicted in FIG. 1, is provided to seal electrical junction boxes 12 correspondingly. Fire protection insert 10 has a rectangular base body 22, which has, in the embodiment depicted here, essentially the shape of bottom 14 of electrical junction box 12. In addition, on edges 24 of base body 22, side elements 26 are provided in each instance, which each have, as explained below, the shape of a side wall 15 of peripheral wall 16 of electrical junction box 12.

In the embodiment depicted here, fire protection insert 10 has a core made of a glass fiber fabric, which gives fire protection insert 10 sufficient stability and flexibility. The glass fiber fabric is completely integrated in fire protection insert 10.

As one can see in FIG. 1, side elements 26 are connected in a one-piece manner with base body 22, wherein between side elements 26 and base body 22, there is provided in each instance a folding edge 28, which is formed by a groove. Side elements 26 are thereby pivotably mounted on base body 22.

On the free edges of side elements 26, beads 30 are also provided, which are formed by a thickening of the intumescent material (see also FIG. 2).

Furthermore, breakaway sections 32 are provided on the side elements as well as on base body 22. On these, the intumescent material is designed thinner and/or the glass fiber fabric is cut through.

For mounting purposes, fire protection insert 10 is inserted in such a manner that base body 22 lays flat on bottom 14 of electrical junction box 12. This can take place prior to mounting electrical junction box 12. However, it is also possible that electrical junction box 12 is already mounted on the wall or ceiling, particularly embedded in the concrete in these. The insertion of fire protection insert 10 is also possible for older, already installed electrical junction boxes 12.

Furthermore, in a mounted state, side elements 26 contact peripheral wall 16 and cover in particular openings 20. Breakaway sections 32 are arranged in such a manner that they lie over openings 20. To pass cables or lines through, breakaway sections 32 can be opened so that an aperture is formed for the cable or line. The apertures are designed as an elongated slit so that the fire protection insert contacts the cable or line in a peripheral direction and seals the aperture. If additional openings 20 are provided in electrical junction box 12, which are not assigned any breakaway sections 32, additional apertures can be made in fire protection insert 10, for example by cutting through the fire protection insert. In this case, one shall ensure that the aperture is selected to be only large enough so that there is no gap, through which drafts or noise can penetrate, between fire protection insert 10 and the line or cable. Due to the flexible material out of which the fire protection insert is made, it can be laid around the passed-through lines in a sealing manner. It is thereby preferred that the aperture is smaller than the diameter of the line or cable to be run through.

As one can see in FIG. 2, beads 30 contact the free edges of the adjacent side elements 26 and when inserting the electrical installations, the beads are pressed against the side elements so that an additional seal against noise and drafts results between the adjoining edges. Additional beads may be provided on the free edges of side elements 26 or at the apertures.

In the event of fire, the intumescent material of fire protection insert 10 foams and thereby also seals the entire electrical junction box 12 in the event of fire.

Fire protection insert 10 may be adapted in any desired way to an electrical junction box 12. Preferably, base body 22 has in each case essentially the shape of a bottom 14 of electrical junction box 12 and side elements 26 jointly form peripheral wall 16 of electrical junction box 12.

However, it is also conceivable that base body 22 and side elements 26 cover bottom 14 or peripheral wall 16 only partially, particularly in the region of openings 20, so that these are sealed against noise and drafts and are also sealed by the foaming intumescent material in the event of fire.

In particular, it is possible that only one side element 26 is provided.

Base body 22 can for example also be adapted to the shape of bottom 14 at a later time. It is similarly possible to add folding edges 28 at a later time to achieve an ideal fit to the shape of electrical junction box 12.

1.-10. (canceled)

11. An intumescent fire protection insert for form-fitting insertion in an electrical junction box with a bottom and a peripheral wall which joins the bottom, comprising:
a planar base body, wherein the planar base body has a shape of the bottom of the electrical junction box; and
a side element, wherein the side element is pivotably mounted on an edge of the planar base body and wherein the side element has a shape of a section of the peripheral wall of the electrical junction box.

12. The intumescent fire protection insert according to claim 11, wherein the side element is connected in a one-piece manner to the planar base body.

13. The intumescent fire protection insert according to claim 12, wherein a folding edge formed by a groove is disposed between the planar base body and the side element.

14. The intumescent fire protection insert according to claim 11, wherein a bead or a thickening is disposed on the edge of the planar base body and/or on an edge of the side element.

15. The intumescent fire protection insert according to claim 11, wherein an aperture for a cable or a line is formed by a breakaway section on the planar base body and/or on the side element.

16. The intumescent fire protection insert according to claim 11, further comprising a plurality of side elements, wherein the plurality of side elements are distributed on the edge of the planar base body and wherein the plurality of side elements jointly have a shape of the peripheral wall of the electrical junction box.

17. The intumescent fire protection insert according to claim 11, wherein the side element projects beyond the peripheral wall of the electrical junction box when the side element is installed in the electrical junction box.

18. The intumescent fire protection insert according to claim 11, wherein the fire protection insert has a core made of glass fibers.

19. The intumescent fire protection insert according to claim 11, wherein the fire protection insert has a core made of a glass fiber fabric.

20. The intumescent fire protection insert according to claim 11, wherein the fire protection insert has a foamable binding agent that contains an intumescent substance mixture.

21. An assembly, comprising:
an electrical junction box with a bottom and a peripheral wall which joins the bottom; and
an intumescent fire protection insert disposed within the electrical junction box and including:
a planar base body, wherein the planar base body has a shape of the bottom of the electrical junction box; and
a plurality of side elements, wherein the plurality of side elements are pivotably mounted on an edge of the planar base body and wherein the plurality of side elements jointly have a shape of the peripheral wall of the electrical junction box;
wherein the planar base body completely covers the bottom of the electrical junction box and wherein the plurality of side elements completely cover the peripheral wall of the electrical junction box.
